(19) United States
(12) Patent Application Publication
(10) Pub. No.: US 2006/0008491 A1
(43) Pub. Date: Jan. 12, 2006

(54) Eremophilone and eremophilone derivatives for pest control

(76) Inventors: David Norman Leach, New South Wales (AU); Robert Neil Spooner-Hart, New South Wales (AU); Greg Francis Eaton, Queensland (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/526,692

(22) PCT Filed: Sep. 3, 2003
(86) PCT No.: PCT/AU03/01133

§ 371 Date: Aug. 4, 2005

Related U.S. Application Data
(60) Provisional application No. 60/408,129, filed on Sep. 3, 2002.

(51) Int. Cl. A01N 25/00

(52) U.S. Cl. 424/405

(57) ABSTRACT

This invention relates generally to methods and compositions for controlling pests. More particularly, the invention relates to pest-controlling compositions, comprising as active ingredients, compounds of formula (I) where X, Y, R₁, R₂ and R₃ are defined herein, and to the use of these compositions inter alia for preventing, eradicating, destroying, repelling or mitigating pests. The present invention also relates to processes of preparing compounds of formula (I) by synthesis or obtaining compounds of formula (I) from natural sources such as volatile oil-bearing plants of the Myoporaceae family.

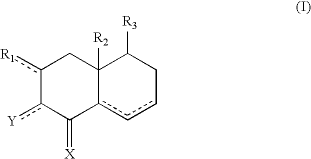

### FIELD OF THE INVENTION

This invention relates generally to methods and compositions for controlling pests. More particularly, the invention relates to pest-controlling compositions, comprising as active ingredients, compounds of formula (I) defined below, and to the use of these compositions inter alia for preventing, eradicating, destroying, repelling or mitigating pests. The present invention also relates to processes of preparing compounds of formula (I) by synthesis or obtaining compounds of formula (I) from natural sources such as volatile oil-bearing plants of the Myoporaceae family.

Bibliographic details of various publications referred to in this specification are collected at the end of the description.

### BACKGROUND OF THE INVENTION

Wood associated pests, such as termites and wood borer beetles, feed on wood and in nature typically aid in the breakdown of dead trees into organic matter. Unfortunately, such pests are not able to determine the difference between dead tree wood and the wood of buildings, structures and wood products such as furniture. Significantly, wood associated pests, especially termites, cause millions of dollars in damage to wooden structures, such as domestic and commercial buildings, worldwide.

Eremophilone is a terpenoid natural product isolated from Eremophila oil, which is an essential oil obtained from the trees of the genus Eremophila in the Myoporaceae family. Eremophilone was first isolated from E. mitchellii in 1932 (Bradfield et al, J. Chem. Soc., 1932) along with other oxygenated derivatives reported six years later (Bradfield et al, 1938). The absolute stereochemistry of eremophilone was not confirmed until 1960 (Djerassi et al, 1960). A detailed review of the phytochemistry of the Myoporaceae has been published recently by Ghisalberti (1994).

### SUMMARY OF THE INVENTION

The instant invention is predicated in part on the discovery that eremophilone and related compounds, such as those obtainable from volatile oil-bearing plants of the Myoporaceae family, exhibit significant pesticidal, pest repellent and/or pest antifeedant activity. This discovery has been reduced to practice in novel pest-controlling compositions and methods for their preparation and use, as described hereinafter.

### DETAILED DESCRIPTION OF THE INVENTION

One aspect of the present invention relates to a pest controlling composition comprising at least one compound of formula (I) or a tautomer thereof: 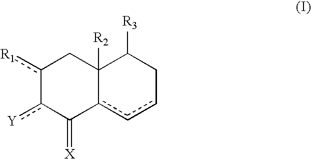
wherein:

X is selected from the group consisting of O, S or N—R₄;
when [symbol] is a single bond attached to Y, Y is selected from the group consisting of H, [C(R₇)₂]ₙhalo, [C(R₇)₂]ₙOR₅, [C(R₇)₂]ₙSR₅, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;

when [symbol] is a double bond attached to Y, Y is O;

when [symbol] is a single bond attached to R₁, R₁ is selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;

when [symbol] is a double bond attached to R₁, R₁ is CR₁ₐR_{1b} wherein R₁ₐ and R_{1b} are independently selected from C₁-C₁₀alkyl;

R₂ and R₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═N)R₆, [C(R₇)₂]ₙNO₂ and [C(R₇)₂]ₙNR₄OR₈;

each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;

R₅ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, (C═O)R₆, PO₃R₈, SO₃R₈ and SO₂R₈;

R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;

R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;

R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl;

n is 0 or an integer selected from 1 to 5; 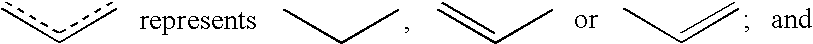
wherein each alkyl, alkenyl, alkynyl, cycloalkyl, cycloalkenyl, aryl and heterocyclyl group is optionally substituted.

In some embodiments the composition further comprises one or more of an adjuvant, additive or carrier.

A further aspect of the present invention relates to a pest controlling composition comprising more than one compound of formula (I) or a tautomer thereof: 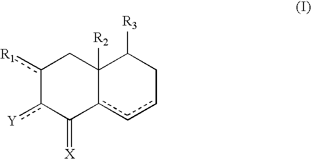
wherein:

X is selected from O, S or N—R₄;

when [symbol] is a single bond attached to Y, Y is selected from the group consisting of H, [C(R₇)₂]ₙhalo, [C(R₇)₂]ₙOR₅, [C(R₇)₂]ₙSR₅, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;

when [symbol] is a double bond attached to Y, Y is O;

when [symbol] is a single bond attached to R₁, R₁ is selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;

when [symbol] is a double bond attached to R₁, R₁ is CR₁ₐR_{1b} wherein R₁ₐ and R_{1b} are independently selected from C₁-C₁₀alkyl;

R₂ and R₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;

each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;

R₅ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, (C═O)R₆, PO₃R₈, SO₃R₈ and SO₂R₈;

R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;

R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;

R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl;

n is 0 or an integer selected from 1 to 5; 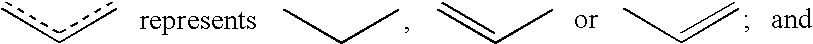
wherein each alkyl, alkenyl, alkynyl, cycloalkyl, cycloalkenyl, aryl and heterocyclyl group is optionally substituted.

In a preferred embodiment, the compounds of formula (I) are those of formula (II): 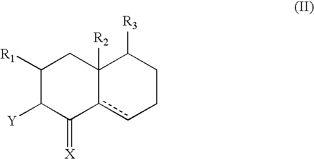
wherein:

X is selected from the group consisting of O, S or N—R₄;

Y is selected from the group consisting of H, [C(R₇)₂]ₙhalo, [C(R₇)₂]ₙOR₅, [C(R₇)₂]ₙSR₅, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;

R₁, R₂ and R₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O))R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;

each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;

R₅ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, (C═O)R₆, PO₃R₈, SO₃R₈ and SO₂R₈;

R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;

R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;

R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl;

n is 0 or an integer selected from 1 to 5;

[symbol] represents a single or double bond; and

wherein each alkyl, alkenyl, alkynyl, cycloalkyl, cycloalkenyl, aryl and heterocyclyl group is optionally substituted.

The compositions of the invention are particularly useful for controlling wood associated pests, including but not limited to, termites and wood borer beetles.

As used herein, the term “alkyl” refers to linear or branched hydrocarbon chains. Suitable alkyl groups include, but are not limited to, methyl, ethyl, propyl, isopropyl, butyl, isobutyl, pentyl, isopentyl, neopentyl, hexyl, heptanyl, octyl, nonyl and decyl.

As used herein, the term “alkenyl” refers to linear or branched hydrocarbon chains containing one or more double bonds. Suitable alkenyl groups include, but are not limited to, ethenyl, prop-2-enyl, 1-methylethenyl, prop-l-enyl 1-methylprop-1-enyl, 1,2-dimethylprop-1-enyl, butenyl and pentenyl.

As used herein, the term “alkynyl” refers to linear or branched hydrocarbon chains containing one or more triple bonds. Suitable alkynyl groups include, but are not limited to, ethynyl and propynyl.

As used herein the term “halogen” refers to fluorine, chlorine, bromine and iodine.

As used herein the term “aryl” refers to aromatic carbocyclic ring systems such as phenyl or naphthyl, especially phenyl.

As used herein the terms “heterocycle”, “heterocyclic”, “heterocyclic systems” and the like refer to a saturated, unsaturated, or aromatic carbocyclic group having a single ring, multiple fused rings (for example, bicyclic, tricyclic, or other similar bridged ring systems or substituents), or multiple condensed rings, and having at least one heteroatom such as nitrogen, oxygen, or sulfur within at least one of the rings. This term also includes “heteroaryl” which refers to a heterocycle in which at least one ring is aromatic. Any heterocyclic or heteroaryl group can be unsubstituted or optionally substituted with one or more groups, as defined above. Further, bi- or tricyclic heteroaryl moieties may comprise at least one ring, which is either completely, or partially, saturated. Suitable saturated heterocyclyl moieties include, but are not limited to, pyrrolidinyl, piperidinyl, piperazinyl and morpholinyl. Suitable heteroaryl moieties include, but are not limited to, oxazolyl, thiazolyl, thienyl, furyl, 1-isobenzofuranyl, 2H-pyrrolyl, N-pyrrolyl, imidazolyl, pyrazolyl, isothiazolyl, isooxazolyl, pyridyl, pyrazinyl, pyrimidinyl, pyradazinyl, indolizinyl, isoindolyl, indoyl, indolyl, purinyl, phthalazinyl, quinolyl, isoquinolyl, oxadiazolyl, thiadiazolyl, tetrazolyl, thiatriazolyl, oxatriazolyl, pyronyl, coumarinyl, chromanyl, isochromanyl and triazolyl.

As used herein, the term “cycloalkyl” refers to cyclic hydrocarbon groups. Suitable, cycloalkyl groups include, but are not limited to cyclopropyl, cyclobutyl, cyclopentyl and cyclohexyl.

The term “cycloalkenyl” as used herein, refers to unsaturated cyclic hydrocarbon groups having a double bond in the ring. Suitable cycloalkenyl groups include, but are not limited to cyclopropenyl, cyclobutenyl, cyclopentenyl and cyclohexenyl.

When each of alkyl, alkenyl, alkynyl, cycloalkyl, cycloalkenyl, aryl and herterocyclyl are optionally substituted, the optional substituents are preferably selected from one or more substituents selected from the group consisting of halogen, hydroxy, thiol, nitro, C₁-C₅ alkoxy, C₂-C₅ alkenyloxy, cyano, carboxy, carboxyC₁-C₅alkyl, NH₂, NH(C₁-C₅ alkyl), N(C₁-C₅ alkyl)₂, NHOH, CF₃, C₁-C₅ alkylthio, SO₂H, SO₃H, SO₂C₁-C₅ alkyl, SO₃C₁ -C₅ alkyl.

As used herein, the term “tautomer” refers to isomers which may be reversibly interconverted by the transfer of a mobile hydrogen atom. For example, in the compound of formula (I), when X is O and [symbol] Y is ═O, a 1,2-diketone is formed. However the compound may also exist as an enol tautomer where the ring junction hydrogen is transferred to the X oxygen with a concomitant shift of the double bond into the ring to provide a tautomer of the form: 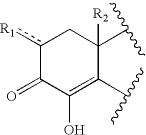
Such tautomers are also included in the compounds of formula (I).

It should be appreciated that some of the compounds of formula (I) are capable of existing as different stereoisomers such as geometric isomers, enantiomers and diastereomers. The invention thus includes both the individual stereoisomers and mixtures of such stereoisomers.

The articles “a” and “an” are used herein to refer to one or to more than one (i.e., to at least one) of the grammatical object of the article. By way of example, “an element” means one element or more than one element.

As used herein the terms “pesticide” or “pesticidal” refer to activity resulting in a high mortality rate in a pest population or activity that interferes with and/or disrupts normal growth, development and functioning of pests.

As used herein the terms “termiticide” or “termiticidal” refer to pesticidal activity resulting in a high mortality rate in a termite population or activity that interferes with and/or disrupts normal growth, development and functioning of termites.

The term “antifeedant” as used herein refers to a compound that reduces the level of normal feeding by an organism.

The term “repellent” as used herein refers to a compound or substance that results in a change in direction of movement of an organism away from that compound or substance.

As used herein, the term “pest” is used in its broadest context and includes insects, arachnids, helminths and molluscs but excludes microbes.

The term “wood associated pest” refers to pests which bore into wood or timber and/or consume, damage or weaken wood, timber and/or wood or timber based products. Such pests include but are not limited to, termites, wood borer beetles, millipedes, isopods, weevils, moths and their larvae. For example, the larva of any one of numerous species of boring beetles, such as slaters, longicom beetles, buprestidans, and certain weevils, the larva of any one of various species of lepidopterous insects, especially of the clearwing moths, the peach-tree borer and the goat moths, the larva of various species of hymenopterous insects of the tribe Urocerata, any one of several bivalve shells that bore into wood, such as the teredos, and species of Xylophaga and any one of several species of small Crustacea, such as the Limnoria, and the boring amphipod (Chelura terebrans).

Preferred compounds of formula (I) having pesticidal activity are those where Y is H and 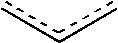
represents 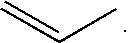
Particularly preferred compounds of formula (I) or formula (II) having pesticidal activity are those represented by formula (III): 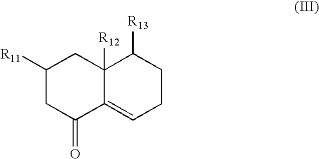
wherein

R₁₁ is selected from the group consisting of C₂-C₁₀ alkenyl, C₇-C₁₂ arylalkyl, C₆-C₁₂ heteroarylalkyl and C₂-C₁₀ alkenyloxy wherein each C₂-C₁₀ alkenyl or C₂-C₁₀ alkenyloxy is optionally substituted with 1 to 3 halo, hydroxy, thiol or nitro groups; and

R₁₂ and R₁₃ are independently selected from the group consisting of H, C₁-C₁₀ alkyl, C₂-C₁₀ alkenyl, C₂-C₁₀ alkynyl, C₆-C₁₀ aryl, C₇-C₁₂ arylalkyl, C₃-C₁₀ cycloalkyl, C₅-C₁₀ heteroaryl, C₆-C₁₂ heteroarylalkyl and C₁-C₁₀ alkoxy, wherein each C₁-C₁₀ alkyl and C₁-C₁₀ alkoxy is optionally substituted with 1 to 3 halo, hydroxy, thiol or nitro groups.

More preferably in compounds of formula (III), R₁₁ is C₂-C₁₀ alkenyl optionally substituted with a hydroxy, nitro or thiol group or 1 to 3 halo groups, and R₁₂ and R₁₃ are independently selected from C₁-C₁₀ alkyl optionally substituted with a hydroxy, nitro or thiol group or 1 to 3 halo groups.

An especially preferred compound of formula (I) having pesticidal activity is eremophilone which has the following formula:

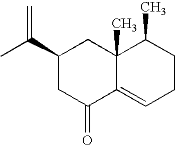

Preferred compounds of formula (I) or formula (II) having antifeedant activity are those where 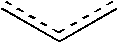
represents

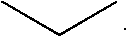

Particularly preferred compounds of formula (I) or formula (II) having antifeedant activity are those represented by formula (IV): 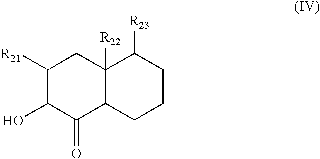
where R₂₁, R₂₂ and R₂₃ are defined as for R₁, R₂ and R₃ in formula (I) above.

More preferably, in compounds of formula (IV), R₂₁ is selected from the group consisting of C₂-C₁₀ alkenyl, C₇-C₁₂ arylalkyl, C₆-C₁₂ heteroarylalkyl and C₂-C₁₀ alkenyloxy wherein each C₂-C₁₀ alkenyl or C₂-C₁₀ alkenyloxy is optionally substituted with 1 to 3 halo, hydroxy, thiol or nitro groups; and

R₂₂ and R₂₃ are independently selected from the group consisting of H, C₁-C₁₀ alkyl, C₂-C₁₀ alkenyl, C₂-C₁₀ alkynyl, C₆-C₁₀ aryl, C₇-C₁₂ arylalkyl, C₃-C₁₀ cycloalkyl, C₅-C₁₀ heteroaryl, C₆-C₁₂ heteroarylalkyl and C₁-C₁₀ alkoxy, wherein each C₁-C₁₀ alkyl and C₁-C₁₀ alkoxy is optionally substituted with 1 to 3 halo, hydroxy, thiol or nitro groups.

Especially preferred compounds of formula (IV) are where R₂₁ is C₂-C₁₀ alkenyl, optionally substituted with a hydroxy, thiol or nitro group or 1 to 3 halo groups, and R₂₂ and R₂₃ are independently selected from C₁-C₁₀ alkyl, optionally substituted with a hydroxy, thiol or nitro group or 1 to 3 halo groups.

An especially preferred compound of formula (I) having antifeedant activity is 8-hydroxy-1(10) dihydroeremophilone which has the following formula:

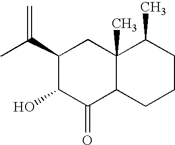

Other preferred compounds of formula (I) having pesticidal activity are those where 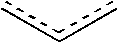
represents

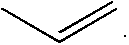

Preferred compounds of formula (I) are those represented by formula (V): 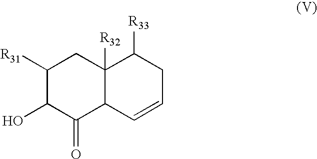
wherein R₃₁ is selected from the group consisting of C₂-C₁₀ alkenyl, C₇-C₁₂ arylalkyl, C₆-C₁₂ heteroarylalkyl and C₂-C₁₀ alkenyloxy wherein each C₂-C₁₀ alkenyl or C₂-C₁₀ alkenyloxy is optionally substituted with 1 to 3 halo, hydroxy, thiol or nitro groups; and

R₃₂ and R₃₃ are independently selected from the group consisting of H, C₁-C₁₀ alkyl, C₂-C₁₀ alkenyl, C₂-C₁₀ alkynyl, C₆-C₁₀ aryl, C₇-C₁₂ arylalkyl, C₃-C₁₀ cycloalkyl, C₅-C₁₀ heteroaryl, C₆-C₁₂ heteroarylalkyl and C₁-C₁₀ alkoxy, wherein each C₁-C₁₀ alkyl and C₁-C₁₀ alkoxy is optionally substituted with 1 to 3 halo, hydroxy, thiol or nitro groups.

More preferably in compounds of formula (V), R₃₁ is C₂-C₁₀ alkenyl optionally substituted with a hydroxy, nitro or thiol group or 1 to 3 halo groups, and R₃₂ and R₃₃ are independently selected from C₁-C₁₀ alkyl optionally substituted with a hydroxy, nitro or thiol group or 1 to 3 halo groups.

An especially preferred compound of formula (V) having termiticidal activity is 8-hydroxyeremophila-1,11-dienone having the formula:

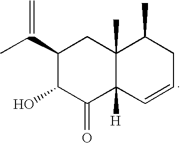

By way of example, compounds of formulae (I) and/or (III) encompassed by the present invention include, but are not restricted to, compounds having the following structural formulae:

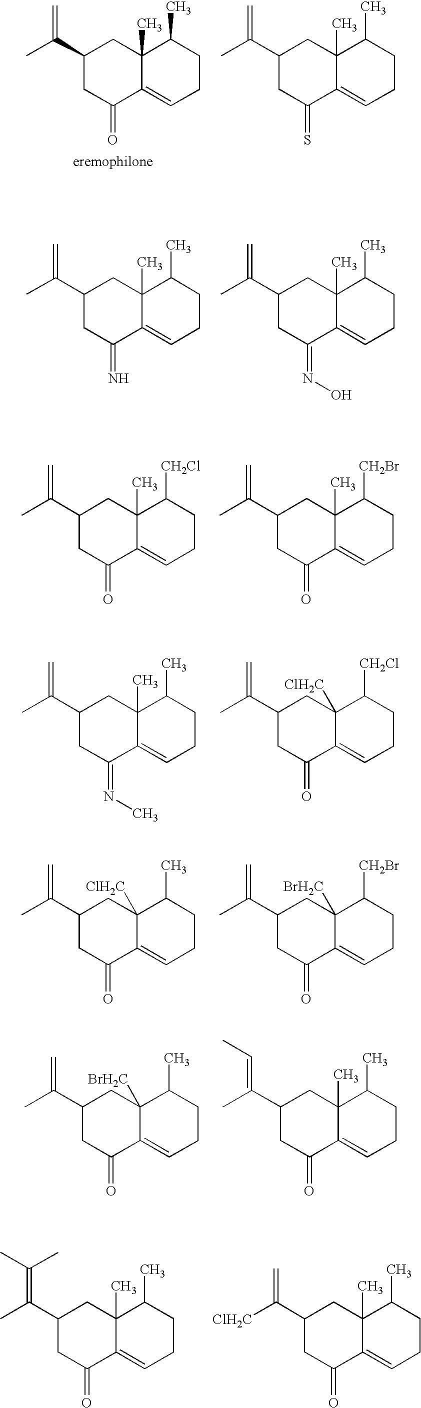

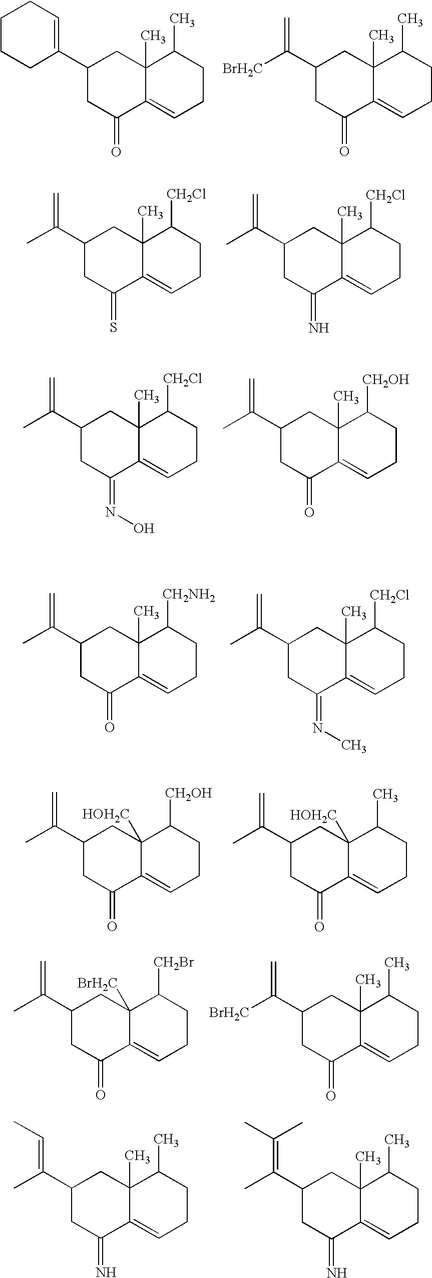

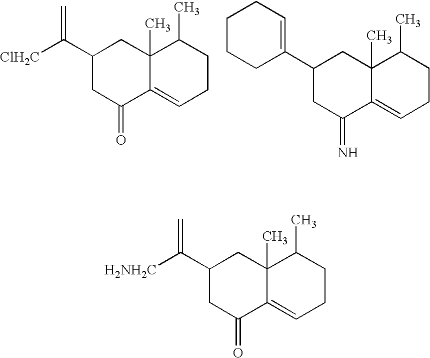

By way of example, compounds of formulae (I) and/or (IV) encompassed by the present invention include, but are not restricted to, compounds having the following structural formulae:

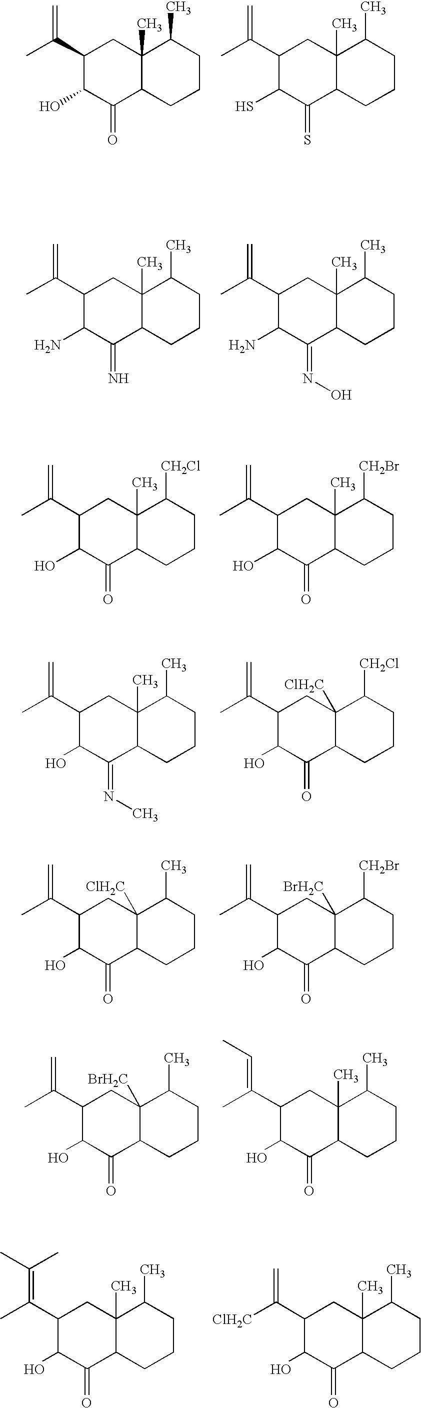

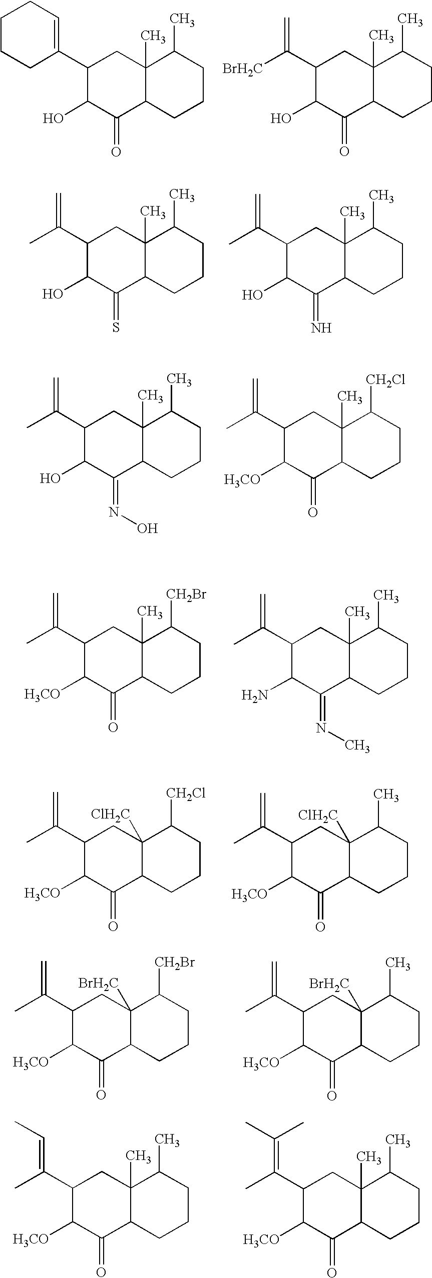

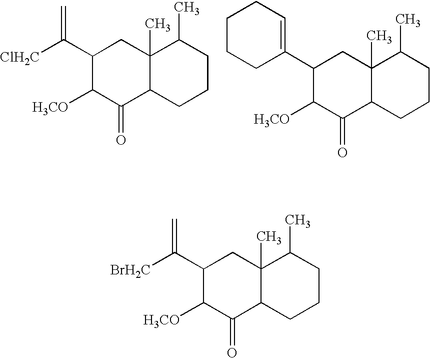

By way of example, compounds of formulae (I) and/or (V) encompassed by the present invention include, but are not restricted to, compounds having the following structural formulae: 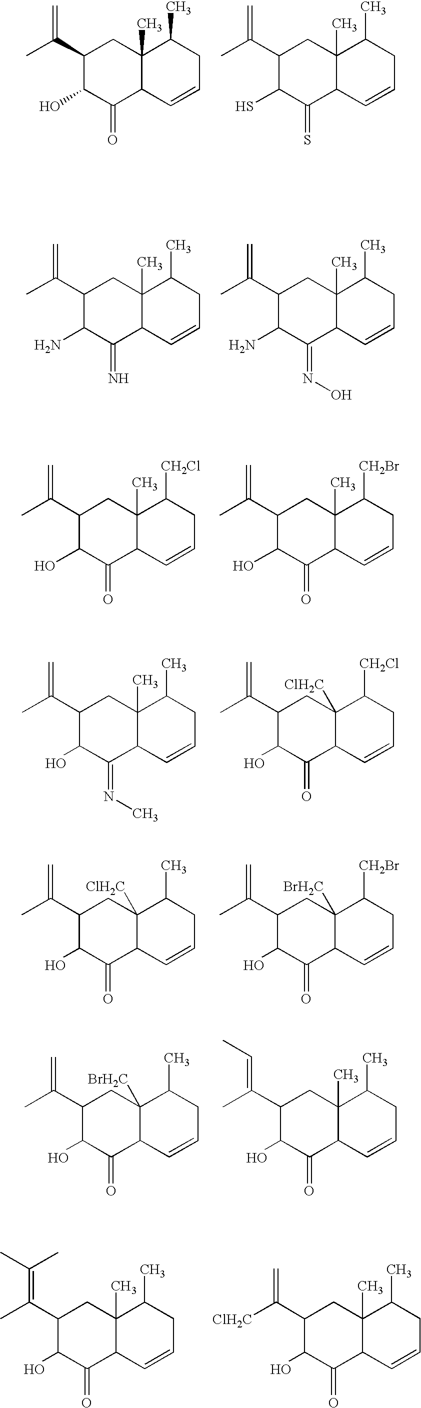 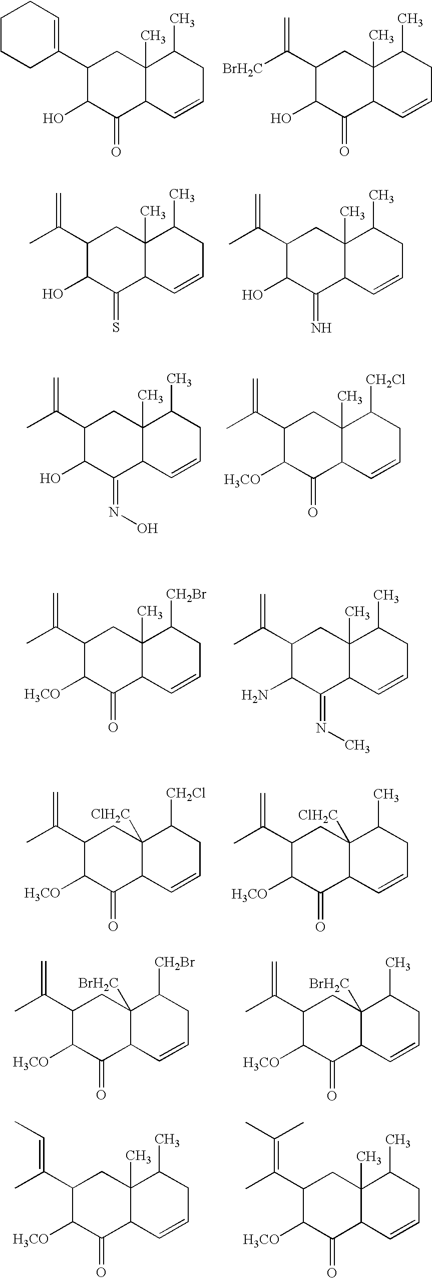 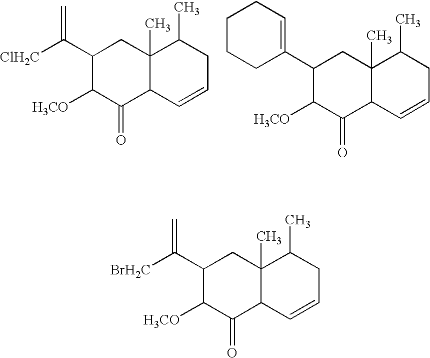
Similarly effective as pest controlling compounds are, where appropriate, salts of the above compounds, including mono-valent salts (e.g., sodium, potassium) and di-valent metal salts (e.g., calcium, magnesium, iron or copper) and ammonium salts (e.g., isopropyl ammonium, trialkyl and tetraalkylammonium salts). Organic salts, such as salts with acetic, propionic, butyric, tartaric, maleic, hydroxymaleic, fumaric, malic, citric, lactic, mucic, gluconic, benzoic, succinic, oxalic, phenylacetic, methanesufonic, toluenesulfonic, benzenesulfonic, salicilic, sulfanilic, aspartic, glutamic, edetic, steric, palmitic, oleic, lauric, pantothenic, tannic, ascorbic and valeric acids, may also be effective.

A number of synthetic methods for preparing eremophilone are known. McMurray et al prepared eremophilone from β-pinene as outlined in Scheme 1.

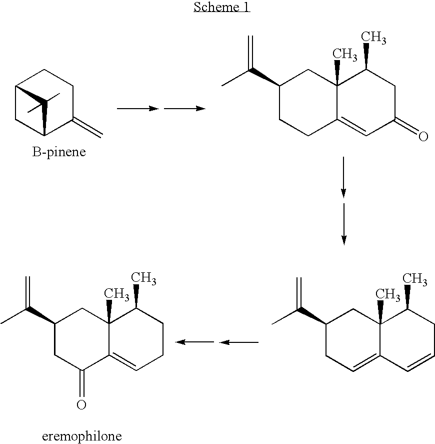

Ziegler et al prepared eremphilone by an alternative synthesis from a cyclohexanone compound as outlined in Scheme 2.

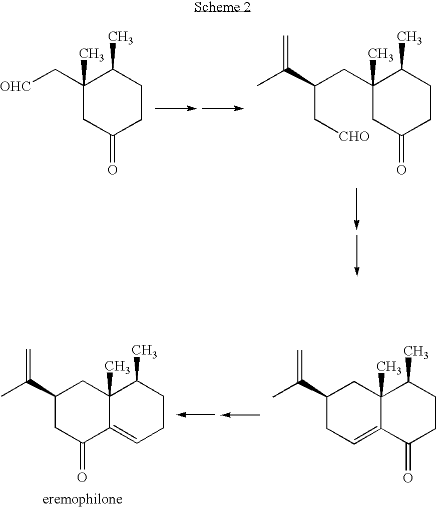

Ficini and Touzin have also prepared eremophilone from a cyclohexenone compound as outlined in Scheme 3.

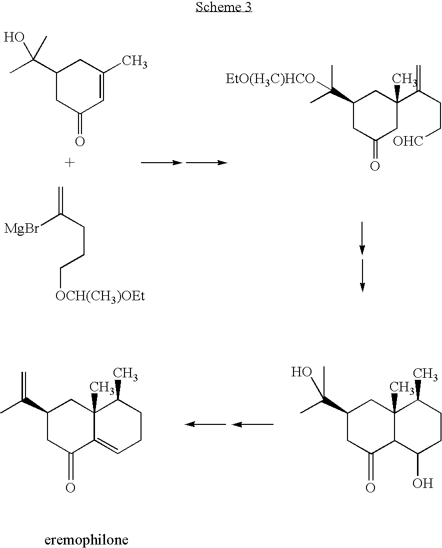

Other compounds of formula (I) may be prepared by methods known in the art. For example, different substituents may be introduced for R₁, R₂ and R₃ by using the methods of preparing eremophilone above and using starting materials or reagents with appropriate substitution patterns.

Alternatively, functional groups on the eremophilone skeleton may be derivatised. For example, to produce compounds of formula (I) where X is N—R₄, compounds of formula (I) where X is O may be reacted with ammonia or a primary amine. To produce compounds of formula (I) where X is S, compounds of formula (I) where X is O may be reacted with H₂S in the presence of an acid catalyst.

Compounds of formula (I) in which 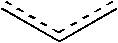
represents 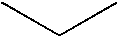
may be prepared by catalytic hydrogenation of compounds of formula (I) where 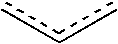
represents 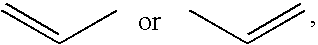
such as treatment with H₂ in the presence of Raney Nickel or palladium-on-charcoal.

In other embodiments, compounds of formula (I) having substituted alkyl groups at R₂ and/or R₃ can be prepared from eremophilone by conversion of the methyl groups at R₂ and/or R₃ into halomethyl groups, for example, by treatment with a N-halosuccinimide such as NBS. If desired these compounds may be further derivatised by nucleophilic substitution with an appropriate nucleophile and/or insertion of methylene groups. By this method it may be possible to produce compounds of formula (I) where R₂ and/or R₃ are optionally substituted C₁-C₁₀ alkyl, C₂-C₁₀ alkenyl, C₂-C₁₀ alkynyl, C₇-C₁₂ arylalkyl, C₈-C₁₀ arylalkenyl, C₄-C₁₀ cycloalkylalkyl, C₄-C₁₀ cycloalkenylalkyl and C₄-C₁₂ heterocyclylalkyl, [C(R₇)₂]ₙ(C═O)R₆, [C(R₇)₂]ₙ(C═S)R₆, [C(R₇)₂]ₙNR₄)₂, [C(R₇)₂]ₙ(C═NR₄)R₆, [C(R₇)₂]ₙNO₂ and [C(R₇)₂]ₙNR₄OR₈. Alternatively compounds of formula (I) where R₂ and/or R₃ are optionally substituted C₁-C₁₀ alkyl or C₄-C₁₂ heterocyclylalkyl may be prepared by coupling compounds of formula (I) where R₂ and/or R₃ is CH₂halo with an alkylhalide or halo(CH₂)ₙheterocyclyl, respectively, in the presence of CuLi.

Compounds of formula (I) where Y is a hydroxy derivative, such as alkoxy, alkenyloxy, carboxylate, phosphate or sulfate may be prepared by reaction of compounds of formula (I) where Y is OH with alkyl or alkenyl halides, carboxylic, phosphoric or sulfuric acids. Alternatively, Y may be introduced into compounds of formula (I) where X is O using well known methods such as substitution at the α-position to a carbonyl group.

Compounds of formula (I) where R₁ is other than a 1-methylethenyl group may be prepared by treatment of eremophilone with a hydrogen halide to afford an alkyl halide. The alkyl halide may be further derivatised by nucleophilic substitution to provide substituents at R₁ such as optionally substituted C₁-C₁₀ alkyl, C₂-C₁₀ alkenyl, C₂-C₁₀ alkynyl, C₇-C₁₂ arylalkyl, C₈-C₁₀ arylalkenyl, C₄-C₁₀ cycloalkylalkyl, C₄-C₁₀ cycloalkenylalkyl and C₄-C₁₂ heterocyclylalkyl.

Alternatively, the compounds of formula (I) may be obtained from natural sources and, in particular, from volatile oil-bearing organisms. Accordingly, in another aspect, the present invention encompasses the use of compounds of formula (I) obtainable from a volatile oil-bearing organism in the preparation of a pesticidal composition.

The present invention also relates to the use of any volatile oil-bearing organism that produces compounds of formula (I) for the preparation of the pesticidal compositions of the invention. Preferred volatile oil-bearing organisms are volatile oil-bearing plants including, but not restricted to, plants from the family Myoporaceae. Preferably, the volatile oil-bearing plant is selected from genera of the Myoporaceae family including, but not limited to, Eremophila, Myoporum and Bonita with the genus Eremophila being native to Australia. There are presently 209 species of Eremophila recognised, however the phytochemistry has only been reported in relation to less than 100 species. Natural products containing the eremophilane and eudesmane skeletons are known to be obtainable from the species E. mitchellii, E. scoparia and E. rotundifolia. However several species are known to produce terepene rich essential oil and hence chemotypes that could include eremophilone and/or analogues thereof include: E. alternifolia, E. duttonii, E. Freelingii, E. loitifolia, E. cuizeifolia, E. dalayana, E. abietina, E. caerulea, E. virgata, E. interstans, E. flaccida, E. Zeucoplylla, E. metallicoruin, E. georgei, E. subteritifolia.

Thus, the compositions of the present invention may contain as active ingredients substantially purified compounds of formula (I) or crude extracts containing compounds of formula (I), obtained from a volatile oil-bearing organism, preferably a volatile oil-bearing plant. Volatile oils, also known in the art as essential oils, typically comprise a volatile mixture of esters, aldehydes, alcohols, ketones and terpenes, which can be prepared from botanical materials or plant cell biomass from cell culture. By way of example, volatile oils may be obtained by subjecting botanical materials to a distillation process. A number of different procedures can be used for distillation. For example, plant matter (e.g., foliage, stems, roots, seeds, bark etc) of a volatile oil-bearing plant is placed in a suitable still and steam distillation is used to break down the cells of the plant to release the oil. The steam is then condensed and the oil phase is separated from the aqueous phase to obtain the volatile oil. It will be appreciated that other methods of volatile oil extraction (e.g., solvent extraction) are known to those of skill in the art and it will be understood, in this regard, that the present invention is not limited to the use or practice of any one particular method of extracting volatile oils.

The compositions of the invention may comprise naturally-occurring compounds derived from a volatile oil-bearing organism. Thus, in a preferred embodiment, the composition of the invention comprises at least one compound of formula (I) as an active compound, that are derived from the volatile oil of a volatile oil-bearing organism. In this embodiment, the composition may optionally contain a naturally-occurring carrier and/or other naturally-occurring additives.

Naturally-occurring additives encompassed by the present invention include natural antioxidants, which can be used advantageously to reduce the effect of oxidation of the compounds of the invention. An example of a suitable naturally-occunring antioxidant is α-tocopherol. Other additives, such as naturally-occurring stabilisers, are also contemplated, which may desirably be added to improve the stability and shelf life of the composition. Examples of suitable natural stabilisers include gum arabic, guar gum, sodium caseinate, polyvinyl alcohol, locust bean gum, xanthan gum, kelgum, and mixtures thereof.

In an alternate embodiment, the naturally-occurring compounds obtained from a volatile oil may be modified or derivatised to improve, for instance, their shelf-life, stability, activity and/or bioavailability.

The compounds of the present invention are useful for controlling pests. They may be used singularly or in combination with other pest-controlling compounds of the invention. By “controlling” is meant preventing, combating, eradicating, destroying, repelling, or mitigating pests or increasing the mortality or inhibiting the growth and/or development of pests. Suitable applications for such control include, but are not limited to, combating and/or eradicating infestations by wood associated pests in wooden structures or buildings and/or plants (including trees) and/or stored or manufactured wooden products. This may be achieved by the application of an effective amount of a compound of the formula (I) to the wooden structures, buildings, plants, stored or manufactured wooden products.

By “effective amount” is meant the application of that amount of active compound, either in a single dose or as part of a series, that is effective for controlling a significant number of pests. Thus, for example, a “pesticidally-effective” amount is the amount of active compound that is effective for increasing the mortality or decreasing the growth of a significant number of pests. Alternatively, a “pest-repelling” effective amount is the amount of active compound that is noxious to, and/or induces behavioural changes in, a significant number of pests. An “antifeedant” effective amount is an amount that reduces the level of normal feeding by a pest. The effective amount will vary depending upon the formulation of the composition, the mode of application and other relevant factors. It is expected that the amount will fall in a relatively broad range that can be determined through routine trials.

Accordingly, the compounds of formula (I) can be used as pesticides, as pest repellents and/or as pest antifeedants. The compounds of formula (I) may be used to control pests alone or as plant extracts without dilution or formulation. However, the compounds may be applied as formulations containing the various adjuvants and carriers known to or used in the industry for facilitating bioavailability, stability and dispersion. The choice of formulation and mode of application for any given compound may affect its activity, and selection will be made accordingly.

In general, a pest-controlling compound of formula (I) can be mixed with appropriate inert carriers and additives in an appropriate ratio by means of dissolving, separating, suspending, mixing, impregnating, adsorbing or precipitating to formulate the compounds of formula (I) into oil formulations, emulsifiable concentrates, wettable powders, flowables, granules, powders, dusts, solutions, suspensions, emulsions, controlled-release forms such as microcapsules, aerosols or fumigants. Typically, the compounds of formula (I) are mixed with a solid carrier, liquid carrier or gas carrier, optionally together with a surfactant and other adjuvants useful for such formulations.

The compounds of the invention may be used in an amount from about 0.00005% to about 90% by weight as contained in these formulations as their active component. As used herein, the term “about” refers to a quantity, level, value or amount that varies by as much as 30%, preferably by as much as 20%, and more preferably by as much as 10% to a reference quantity, level, value or amount.

Where the compounds of formula (I) are in the form of plant extracts, the formulations will usually comprise as their principal active ingredient from about 0.0001% to about 90%, preferably from about 0.0001% to about 50%, more preferably from about 0.0005% to about 10%, even more preferably from about 0.0005% to about 5%, even more preferably from about 0.0005% to about 1% and still even more preferably from about 0.001% to about 1% by weight of the extract.

Alternatively, where the compounds of formula (I) are substantially purified, the formulations will usually comprise as their principal active ingredient from about 0.00005% to about 90%, preferably from about 0.0001% to about 50%, more preferably from about 0.0005% to about 10%, even more preferably from about 0.001% to about 5% and still even more preferably from about 0.001% to about 0.5% by weight of the substantially purified compound.

By “substantially purified” is meant a compound of formula (I) which has been separated from components that naturally accompany it. Typically, a compound is substantially pure when at least 60%, more preferably at least 75%, more preferably at least 90%, and most preferably at least 99% of the total material (by volume, by wet or dry weight, or by mole percent or mole fraction) in a sample is the compound of interest. Purity can be measured by any appropriate method, e.g., by chromatography or HPLC analysis. For those compounds prepared by synthetic procedures or derivatisation of a naturally occurring compound, “substantially purified” refers to a compound that has been separated from the reagents and solvents used in the synthetic procedure. Typically a synthetically prepared compound is substantially pure when at least 75%, more preferably at least 90%, and most preferably at least 99% of the total material (by volume, by wet or dry weight, or by mole percent or mole fraction) in a sample is the compound of interest.

Examples of solid carriers useful in preparing the formulations are clays including kaolin clay, diatomite, water-containing synthetic silicon oxide, bentonite, Fubasami clay, and acid clay; sand, soil, talcs; ceramics; inorganic minerals such as Celite, quartz, suifir, active carbon, calcium carbonate and hydrated silica; and chemical fertilisers such as ammonium sulfate, ammonium phosphate, ammonium nitrate, urea and ammonium chloride, these solid carriers being finely divided or granular. Examples of useful liquid carriers are water, alcohols such as methanol and ethanol, ketones such as acetone and methyl ethyl ketone, aromatic hydrocarbons such as benzene, toluene, xylene, ethylbenzene and methylnaphthalene, aliphatic hydrocarbons such as hexane, cyclohexane, kerosene and light oil, esters such as ethyl acetate and butyl acetate, nitrites such as acetonitrile and isobutyronitrile, ethers such as diisopropyl and dioxane, acid amides such as N,N-dimethylformamide and N,N-dimethylacetamide, halogenated hydrocarbons such as dichloromethane, trichloroethane and carbon tetrachloride, dimethyl sulfoxide, and fish oils, mineral oils, plant derived oils such as canola oil, cotton-seed oil, soybean oil and sesame oil as well as essential oils such as lavender oil, eucalyptus oil, tea tree oil, citrus oil etc. Solid or liquid carriers can be used alone or in combination. Examples of gas carriers, i.e., those of propellants, are butane gas, LPG (liquefied petroleum gas), dimethyl ether, fluorocarbons and carbon dioxide gas.

Examples of surfactants are alkylsulfuric acid esters, alkylsulfonic acid salts, alkylarylsulfonic acid salts, alkyl aryl ethers and polyoxyethylene adducts thereof, polyethylene glycol ethers, polyhydric alcohol esters, sugar alcohol derivatives, sorbitane monolaurate, alkylallyl sorbitane monolaurate, alkylbenzene sulfonate, alkylnaphthalene sulfonate, lignin sulfonate, and sulfuric acid ester salts of higher alcohols. These surfactants may be used alone or in combination.

Examples of adjuvants for the formulations, such as binders and dispersants, are casein, gelatin, polysaccharides such as starch, gum arabic, cellulose derivatives and alginic acid, lignin derivatives, bentonite, sugars and water-soluble synthetic high-molecular-weight substances such as polyvinyl alcohol, polyvinyl pyrrolidone and polyacrylic acids. Examples of stabilisers are PAP (acid isopropyl phosphate), BHT (2,6-di-tert-butyl-4-methylphenol), BHA (mixture of 2-tert-butyl-4-methoxyphenol and 3-tert-butyl-4-methoxyphenol), synergists such as piperonyl butoxide, vegetable oils, mineral oils, fish oils, surfactants and fatty acids or esters thereof.

Emulsifying agents that may be used are suitably one or more of those selected from non-ionic or anionic emulsifying agents. Examples of non-ionic emulsifying agents include, but are not restricted to, polyoxyethylenealkylphenylether, polyoxyethylenealkylether, polyethyleneglycol fatty ester, sorbitan fatty ester, polyoxyethylene sorbitan fatty ester, polyoxyethylenesorbitol fatty ester, polyoxyethylenepolyoxypropylenealkylether. Examples of anionic emulsifying agents include alkyl sulphates, polyoxyethylenealkylether sulphates, sulfosuccinates, taurine derivatives, sarcosine derivatives, phosphoric esters, alkylbenzenesulfonates and the like. A mixture consisting of polyoxyethylenestyrylphenylether and calcium allylbenzenesulfonate is preferred. These emulsifying agents may be used in an amount of 5 to 20 weight parts per 100 weight parts of the compositions of the present invention.

Formulations thus obtained can be used solus or diluted, for example, with water or other diluent. The formulations can be used also as admixtures with other pesticides such as insecticides, arachnicides, anti-helminthics, molluscicides, herbicides, plant growth regulators, synergists, soil improvers, baits and the like, or can be used simultaneously with such agents without mixing. For example, the pest-controlling compounds of formula (I) can be combined with other naturally derived bioactive compounds or extracts such as neem or its components, derris, pyrethrum, β-triketones; microbial extracts such as avermectins or streptomycins; with synthetic insecticides, acaricides, molluscicides, anti-helminthics; anti-protozoals, or with microorganisms having insecticidal, acaricidal, molluscicidal, anti-helminthic or anti-protozoal e.g., bacteria such as Bacillus thuringiensis, Bacillus popillae, entomogenous fungi such as Metarhizium spp., Verticillium lecanii, nematodes such as Steinernema spp and Heterorhabditis. For example, the compounds of formula (I) may be combined with synthetic pesticides such as chlorpyrifox or chlorpyrifos-methyl, to increase the efficacy of the composition against pests, especially wood associated pests such as termites and wood borer beetles.

Alternatively, or in addition, the pest-controlling compounds of formula (I) can be combined with synergists such as piperonyl butoxide, and with ultraviolet screening compounds of natural or synthetic origin.

The present invention also relates to the use of the above described compounds of formula (I) in pest repellent compositions. Repellent compositions encompassed by the present invention include those that are noxious to, and/or induce behavioural changes in, a pest. The latter compositions suitably comprise an activity including, but not restricted to, an antifeedant activity, an oviposition deterrent activity and an insect growth regulatory activity.

The compounds of formula (I) and their compositions may also be used to combat wood associated pests in the soil, especially subterranean termites, thereby achieving indirect protection of any timber-based construction erected on the treated soil or to crops, grassland, forestry, and other cellulose-based materials surrounded by or located in or on the treated soil. For use in this manner, the compounds or compositions are suitably broadcast onto the soil surface or applied under the soil surface at a rate of from 0.01 grams to 10 kilograms per hectare. In addition to the compositions described above, for this use, a compound of formula (I) can be formulated as a compound impregnated wooden stake. The compounds or compositions may be applied to the soil by any suitable method, for example, by band, furrow, or side-dress techniques or as soil drench.

The compounds of formula (I) and their compositions may also be used to form a wood associated pest barrier beneath or adjacent to a timber- or wood-containing structure, such as a building, to prevent wood associated pests migrating from the soil into the wood of the structure. Such a barrier may be in the form of a layer of soil or sand containing the compounds of the invention or the compounds or compositions may be applied to the top of the soil beneath or surrounding the structure. Alternatively, the compounds may be applied in a band or furrow around the structure to prevent horizontal migration of termites. Other suitable barriers may be formed using, for example, impregnated physical barriers, for example, use of laminates, sawdusts or particle board impregnated with compounds of formula (I) as barriers. Methods for impregnation of physical barriers with pesticides and the like are well known to skilled practitioners in the art.

Thus, in another aspect of the present invention there is provided a method for controlling pests, said method comprising exposing said pests to a pest-controlling effective amount of at least one compound of formula (I) or a composition comprising at least one compound of formula (I) as broadly described above. Preferred embodiments of this type include exposing wood associated pests such as termites and wood borer beetles to a pesticidally effective amount or a pest-repelling effective amount of said at least one compound of formula (I) or a composition containing them. Preferably a pest-repelling effective amount has pest antifeedant activity.

The method of the invention incudes exposing the pests to be controlled to a pest-controlling effective amount of at least one compound of formula (I). The term “exposing” as used herein refers to applying the compounds and compositions of the invention to a site of infestation by the pests, a potential site of infestation by the pest which may require protection from infestation, or the environment around a habitat or potential habitat of the pest. Exposure may be achieved by applying the compound of formula (I) or a composition containing at least one compound of formula (I) onto a surface or impregnating material or physical barrier. The compounds and compositions of the invention may be applied to a surface of material or article of manufacture such as soil, timber, buildings or physical barriers by, for example, spraying, painting or coating, or may be applied by impregnating a matrix such as soil, sand, sawdust, wood or timber products. Impregnated soil or sand may be applied in a band or furrow around a potential site of infestation, such as a building or may be mixed with a layer of soil at the site of application. Material such as wood, timber or physical barriers may be impregnated, coated or laminated with the compounds or compositions of the invention.

In yet another aspect of the invention there is provided a material or article of manufacture that is coated or impregnated with at least one compound of formula (I) or with a composition containing at least one compound of formula (I). Thus, for example, the compounds of formula (I) and their compositions may be applied directly onto the surface or into the matrix of a material to be protected from termite damage. Such materials or articles of manufacture are thereby resistant to wood associated pest damage.

For example, timber may be treated before, during, or after it is incorporated into a structure or building, thereby protecting it against damage from wood associated pests or combating an already existing wood associated pest infestation. For timber treatment, the compounds of formula (I)-containing compositions may optionally contain a penetrant, such as, for example, parafinic hydrocarbons, 2-ethoxyethanol, or methyl isobutyl ketone, and/or an anti-bloom agent, such as, for example, dibutyl phthalate or o-dichlorobenzene. Timber treatment compositions may also optionally contain fungicides, other insecticides, and/or pigments. For such applications, the compounds of formula I or their compositions may be incorporated into a coating, such as, for example, a paint, stain, or natural wood colorant which is applied to the surface of the timber.

Application of the compounds of the present invention onto the surface or into the matrix of the wood or timber can be accomplished using conventional techniques such as immersion of the timber or wood into a liquid composition, painting by spraying or brushing, dipping, or injecting the composition into the timber or incorporation into particle board or laminates. For such applications, the concentration of the compound of formula (I) in the composition should be sufficient to provide an effective amount of the compound in or on the timber.

Wood or timber may also be impregnated with the compounds of formula (I) using well known procedures such as, for example, pressure treatments such as the Lowery empty cell process and full cell process, vacuum treatment, hot and cold bath treatment, thermal treatment, and cold-soak treatment.

Furthermore the compounds of formula (I) and their compositions may be applied to pest shields and used in pest-proofing systems. Pest shields include metal shields ncorporated during building of the structure to protect areas particularly susceptible to wood associated pest attack, such as window sills, wooden steps, porches and verandahs and lattice work. For example, suitable termite proofing systems include those described in U.S. Pat. No. 6,397,518.

Certain compounds of formula (I) are novel and these form a further aspect of the present invention.

The terms “comprise”, “comprises” and “comprising” and the like refer, unless the context requires otherwise, to the inclusion of a stated step or element or group of steps or elements but not the exclusion of any other step or element or group of steps or elements.

The compositions and methods of the present invention may be applied to pests including insects, arachnids, helminths and molluscs but excluding microbes. In one preferred embodiment, the pests are selected from wood associated pests. Examples of suitable insects that fall within the scope of the pests in the present invention include:
(a) the termites (Isoptera) which may be controlled with compounds of formula (I) and compositions containing compounds of formula (I) include subterranean termites, for example, Calotermes flavicollis, Coptotermes spp such as Coptotermes acinaciforms, Leucotermes flavipes, Macrotermes subhyalinus, Nasutitermes spp such as Nasutitermes walkeri, Odontotermes fonnosanus, Reticulitermes lucifugus, Teznes natalensis, Mastotermes spp., Microtermes spp., Porotermes spp., Heterotermes spp, Shedorhinotermes spp;

(b) the earwigs (Demaptera) such as those from the families Pigidicranidae, Carcinophoridae, Labiidae, Labiduiidae, Chelisochidae and Forficulidae, for example, Forficula auricularia;

(c) the cockroaches (Blattaria), for example, Blattella germanica, Supella logipalpa, Periplaneta americana, Periplaneta bruea, Periplaneta fulginosa, Blatta orientalis, Diploptera punctata, Leucophaea moderae, Blaberus giganteus, Blaberus craniifer, Blaberus discoidalis, Eublaberus posticus, Byrsotria fumigata, Schultesia lampyridiformis, Gromphadorhina portentosa and Gromphadorhina chopardi; and

(d) the wood borer beetles, such as those from the families Lyctidae, Anobhidae, Bostrichidae, Buprestidae and Cerambycidae. For example, Hylotrupes bajulus, Acanthocinus princeps, Plectrodera scalator, Glycobius speciosus, Anoplophora glabripennis, Neoclytus caprea, Agrilus anxius, Spenoptera jugoslavica, Oberea tripunctala, Saperda tridentata, Chrysobothris femorata, Chalcophora mariana and Saperda calcarata.

The present invention also extends to methods for producing resistance in plants to pests by crossing a plant expressing compounds of formula (I) according to the invention with pest susceptible lines. Crossing a compound of formula (I)-producing plant into a pest susceptible background would produce a resistant plant with a high level of pest resistance. Plants that could be made pest resistant include, but are not limited to, dicotyledonous plants, especially trees and more especially trees that are intended to be used in building wooden structures or in wooden products.

As used herein, the term “plant” includes reference to whole plants, plant organs (e.g., leaves, stems, roots, etc.), seeds and plant cells and progeny of same. Plant cell, as used herein includes, without limitation, seeds suspension cultures, embryos, meristematic regions, callus tissue, leaves, roots, shoots, gametophytes, sporophytes, pollen, and microspores. The class of plants which can be used in the methods of the invention is generally as broad as the class of higher plants amenable to transformation techniques, including both monocotyledonous and dicotyledonous plants.

Thus, the present invention also relates to conventional plant breeding methods to transfer the genetic material associated with the production of compounds of formula (I) via crossing and backcrossing. Such methods will comprise the steps of: (1) sexually crossing the plant which produces compounds of formula (I) with a plant from a pest susceptible taxon; (2) recovering reproductive material from the progeny of the cross; and (3) growing pest-resistant plants which contain compounds of formula (I) from the reproductive material. Where desirable or necessary, the agronomic characteristics of the susceptible taxon can be substantially preserved by expanding this method to include the further steps of repetitively: (1) backcrossing the pest-resistant progeny with pest-susceptible plants from the susceptible taxon; and (2) selecting for expression of a compounds of formula (I) (or an associated marker gene) among the progeny of the backcross, until the desired percentage of the characteristics of the susceptible taxon are present in the progeny along with the gene or genes imparting production of compounds of formula (I).

By the term “taxon” herein is meant a unit of botanical classification. It thus includes, genus, species, cultivars, varieties, variants and other minor taxonomic groups which lack a consistent nomenclature.

In order that the invention may be readily understood and put into practical effect, particular preferred embodiments will now be described by way of the following non-limiting examples.

### EXAMPLES

### Example 1

Eremophilone-Containing Oils Obtained From Erentophila Species

Wood samples of Eremophila mitchellii were collected in south-west Queensland in Australia. The wood samples were stored at ambient temperature until required. Samples were cut, then ground to about 2-5 min in size. The ground wood samples were then subjected to steam distillation or extraction.

Steam distillation was performed using a modified Clevenger apparatus and the sample distilled for 4 days. The heavier than water oil was separated, dried over anhydrous magnesium sulphate and stored at 4° C. under Argon.

Samples of 100 g of ground wood were extracted separately with either hexane (500 mL) or methanol (500 mL) with sonication for one hour.

The yields of oil obtained by steam distillation and the solvent extraction protocols are summarised in Table 1:

TABLE 1

| Extraction Method | Yield (%) |
|---|---|
| Steam distillation | 1.7 |
| Hexane extration | 2.4 |
| Methanol extraction | 8.1 |

The oil samples were injected in hexane using the GCMS/GCFID method MS-QCIDE on an Agilent 6890 Gas Chromatograph, equipped with a split/splitless injector, a 7963 Mass Selective Detector (MSD) and a Flame Ionization Detector (FID). Chromatography was performed on a BPX-5 capillary column (50 m×0.22 mm ID and 1 μM film thickness—SGE, Melbourne) connected to the two detectors via a splitter and inert transfer lines (1 m×0.22 mm). One line was terminated at the MSD operating at: transfer temperature: 310° C.; ionization: 70 eV, source temperature: 230° C.; quadrupole temperature: 150° C. and scanning a mass range: 35-550 m/z. The second line was terminated at an FID operating at 300° C.

The injector temperature was 280° C. and the carrier gas was helium at 37.04 psi and an average velocity of 36 cm/sec to the MSD and 31 cm/sec to the FID. The column oven was programmed as follows: initial temperature:100° C.; initial time: 1.0 min; program rate: 8° C./min; final temperature: 300° C.; final time: 10 min.

Four major components of the steam distillation product were identified by GCMS and NMR. The amounts of their compounds are shown in Table 2 and their structural formulae and nmr data are shown below.

TABLE 2

| | GC retention | | |
|---|---|---|---|
| GCMS Peak No. | time (min) | % | Component |
| 1 | 17.47 | 29.7 | Eremophilone |
| 2 | 17.73 | 37.7 | 8-hydroxy-1(10)- |
| | | | dihydroeremophilone |
| 3 | 18.89 | 22.6 | EM 3 |
| 4 | 19.50 | 8.3 | EM 4 |

Eremophilone (EM-1)

Massy-Westropp, et al., 1966; Bradfield, et al., J. Chem Soc. 1932; Bradfield et al. J. Proc. Roy. Soc. N.S.W., 1932; Ziegler, et al. 1977; Bates and Paknikar, 1966.

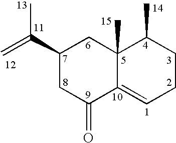

C₁₅H₂₂O MW 218.

¹H NMR δ ppm, (CDCl₃) 0.96, 3H, (CH₃, 14); 0.97, 3H, (CH₃, 15); 1.51, 2H, (CH₂, 3); 1.51, 1H, (6); 1.63, 2H, (CH₂, 4); 1.75, 3H, (CH₃, 13); 1.97, 1H, (6); 2.23, 2H, (CH₂, 2); 2.36, 1H, (CH, 7); 2.41, 1H, (CH₂, 8); 4.74 1H, (12); 4.77, 1H, (12); 6.6, 1H, (CH, 1).

¹³C NMR, δ ppm (CDCl₃) 16.2 (14); 20.8 (13); 25.0 (15); 25.8 (2); 26.7 (3); 36.2 (5); 39.0 (4); 39.3 (7); 41.6 (6); 43.4 (8); 110.2 (12); 135.5 (1); 144.5 (10); 147.8 (11); 204.0 (9).

8-hydroxy-1(10)-dihydroeremophilone (EM-2) (also known as santalcamphor and 8-hydroxy-11 -eremophilen-9-one)

Massy-Westropp, et al., 1966; Bradfield, et al., J. Chem Soc. 1932; Bradfield et al. J. Proc. Roy. Soc. N.S.W., 1932; Bates and Paknikar, 1966.

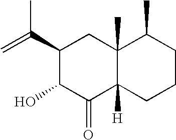

C₁₅H₂₄O₂ MW 236.

¹H NMR δ ppm (CDCl₃) 0.79, 3H, (CH₃, 14); 1.06, 3H, (CH₃, 15); 1.32, 1H, (3); 1.40-1.45; 2H, (3, 4); 1.50-1.60, 3H, (1, 2, 6); 1.60-1.70, 1H, (2); 1.83, 3H, (CH₃, 13); 1.91, 1H, (6); 2.08, 1H, (1); 2.31, 1H (CH, 10); 2.42, 1H, (CH, 7); 4.00, 1H, (CH, 8); 4.90, 1H, (12), 4.93, 1H, (12).

¹³C NMR δ ppm (CDCl₃) 15.4 (14); 19.6 (13); 21.0 (1); 21.5 (15); 22.4 (2); 30.3 (3); 33.9 (4); 40.1 (6); 41.3 (5); 48.1 (7); 54.2 (10); 76.7 (8); 112.3 (12); 145.3 (11); 211.9 (9).

9-hydroxy-7(11),9-eremophiladien-8-one (EM 3)

Massy-Westropp, et al., 1966; Bradfield, et al., J. Chem Soc. 1932; Bradfield et al. J. Proc. Roy. Soc. N.S.W., 1932; Pinder and Torrence, 1971.

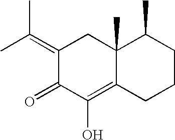

C₁₅H22O₂ MW 234.

¹H NMR δ ppm (CDCl₃) 0.94, 3H, (CH₃, 14); 0.96, 3H, (CH₃, 15); 1.39-1.46, 2H, (3, 2); 1.47-1.51, 1H, (CH, 4); 1.53-1.55, 1H, (3); 1.86, 1H, (2); 1.90, 3H, (CH₃, 12); 1.95, 1H, (1); 2.10, 1H, (6); 2.18, 3H, (CH₃, 12); 2.88, 1H, (6); 2.98, 1H, (1).

¹³C NMR δ ppm (CDCl₃) 15.7 (15); 16.4 (14); 23.2 (2C, 12, 13); 23.8 (1); 25.8 (2); 30.8 (3); 39.8 (5); 40.7 (6); 43.1 (4); 125.9 (7); 137.4 (10); 142.7 (9); 146.7 (11); 185.7 (8).

9-Hydroxy-1,7(11),9-eremophilatriene (EM 4)

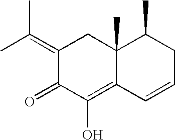

C₁₅H₂₀O₂ MW 232.

The GCMS profile of the hexane and methanol extracts were also the same as the team distilled product.

The steam distillate was also subject to normal phase preparative HPLC using a Phenomenex Luna 5μ Silica column (150×21.20 mm) eluting with ethyl acetate and hexane as a mobile phase. The initial eluent composition was 95% hexane with a solvent gradient of 60% hexane over 20 minutes. Fractions were collected over 1 minute intervals for 28 minutes (1.5 minutes to 29.5 minutes). A further compound EM-5 was found to elute in fractions 8 and 9 with a retention time between 8.5 and 10.5 minutes. EM-5 is 8-hydroxyeremophila-1,11-dienone (Massy-Westropp et al., 1966; Chetty et al., 1969) and has the following formula:

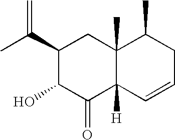

GCMS (as described in Example 1) retention time: 17.5 minutes: C₁₅H₂₂O₂ MW 234.

¹H NMR δ ppm (CDCl₃) 0.82, 3H, (CH₃, 14); 1.0, 3H, (CH₃, 15); 1.58-1.64, 1H, (CH, 4); 1.66, 1H, (6); 1.72-1.80, 1H, (3); 1.84, 3H, (CH₃, 13); 1.93, 1H, (6); 2.10, 1H, (3); 2.33, 1H, (CH, 7); 2.78, 1H, (CH, 10); 4.12, 1H, (CH, 8); 4.90, 1H, (12); 4.93, 1H, (12); 5.67; 1H, (CH, 1); 5.88, 1H (CH, 2).

¹³C NMR δ ppm (CDCl₃) 14.4 (14); 19.4 (13); 21.0 (15); 30.4 (4); 32.2 (3); 39.1 (6); 40.0 (5); 48.4 (7); 56.3 (10); 77.0 (8); 112.6 (12); 122.5 (1); 129.9 (2); 145.0 (11); c.a. 212 (9).

### Example 2

Termiticidal Activity

A number of samples were assessed for termiticidal activity. The steam distilled oil product was separated into thirty fractions using reverse phase preparative HPLC, methanol:water (80:20). Fractions were re-analysed by GC-MS and recombined to provide eight fractions. Three fractions contained pure components, the other fractions contained mixtures of minor components of the oil. Six fractions together with the whole oil distillate, and the methanol and hexane extracts were tested on the workers of the termites Nasutitermes walkeri and Coptotermes acinaciformis as follows.

Twenty uniform termite workers were transferred to 90 mm diam. petri dishes lined with the same diameter moistened filter paper (Whatman No 2). The extract was dissolved in 2 mL of ethyl alcohol and distilled water containing 200 ppm of the surfactant Triton X-100™ (octylphenol ethylene oxide condensate; Union Carbide, Sigma Chemicals, St Louis, Mo., USA) was used to prepare the required stock solution from the extract under investigation. It was possible to prepare a homogeneous and uniform emulsion by thorough agitation. Serial dilutions were prepared using the Triton X-100/distilled water as a diluent.

A 5 ml aliquot was applied to each petri dish with a Potter precision spray tower as described by Herron et al (995). The average weight of the solution sprayed on each dish was calculated to be 3.95 mg/cm². Depending on the amount of the extract available, one to three replicates were treated with each concentration. There was no mortality recorded in the blank control treatment where all workers remained alive and active for >48 h after treatment. Mortality was normally recorded 24 h after treatment. Death was recognised by the absence of movement when the test termite workers were gently prodded. Data were analysed using SPSS [symbol] for Windows™ Version 7 (SPSS Inc. 1997). Probit analysis was carried out for dose-mortality data and heterogeneity of regressions was determined by the Pearson chi-squared characteristic.

The results are shown in Table 3.

TABLE 3

| | | HPLC | | |
|---|---|---|---|---|
| | | Retention | | |
| Termite | | time | LD₅₀ | LD₉₅ |
| species | Sample | (min) | (95% CL) | (95% CL) |
| C. acinaciformis | Whole Oil | | 0.11 | 0.18 |
| | distillate | | | |
| N. walkeri | Whole oil | | 0.054 | 0.11 |
| | distillate | | | |
| C. acinaciformis | EM-F1 | 16.5-19.5 | No mortality | 15% mortality |
| | | | at 24 h | at 48 h |
| C. acinaciformis | EM-F2 | 19.5-21.5 | No mortality | |
| C. acinaciformis | EM-F3 | 21.5-25.5 | 0.05 | 0.07 |
| C. acinaciformis | EM-F4 | 25.5-27.5 | No mortality | |
| C. acinaciformis | EM-F5 | 27.5-30.0 | No mortality | |
| C. acinaciformis | EM-F8 | 0.0-16.5 | 0.064 | 0.195 |
| C. acinaciformis | MEOH | | 0.23 | 0.559 |
| | Extract | | | |
| C. acinaciformis | Hexane | | 0.12 | 0.41 |
| | Extract | | | |

The steam distilled oils were more efficacious than the hexane and methanol extracts on a weight for weight basis. However, making allowance for the dilution of the volatile oil by additional solvent extracted components, it is likely that the two solvent extracts were as efficacious as the oil on a corrected weight basis.

Fractions EM-F2, EM-F4 and EM-F5 were inactive whilst Fraction EM-F3 and EM-F8 showed significant termiticidal activity. EM-F3 was identified as pure eremophilone and is the most potent and hence most active component of the oil. EM-F8 is a complex fraction that appears to contain a number of active components.

Fraction EM-F1 contained 8-hydroxy-1(10)-dihydroeremophilone. This fraction caused changes in the termite worker behaviour in that they became inactive, disoriented and did not feed. When left for 48 hours, mortality of the termites exposed to EM-F1 commenced. This fraction has antifeedant activity.

### Example 3

The bioassay of Example 2 was repeated with the whole oil extract and compounds EM-1, EM-2, EM-3 and EM-5 as isolated by normal phase HPLC of the whole oil extract, as described in Example 1.

Preliminary results showing LD₅₀ values at 24 hours and 48 hours are given in Table 4.

TABLE 4

| compound | LD₅₀ (24 hours) | LD₅₀ (48 hours) |
|---|---|---|
| EM-1 | 0.16 | 0.1 |
| EM-2 | 0.68 | 0.32 |
| EM-3 | 0.45 | 0.30 |
| EM-5 | 0.21 | 0.21 |
| whole oil | 0.17 | 0.12 |
| distillate | | |

### Example 4

Barrier Treatment

Investigations were conducted on the efficacy of E. mitchellii oil as a barrier treatment to prevent termite incursions. The methodology employed used bioassay tubes modified from Su et al. (1995). Pyrex medium wall test tubes (24×200 mm Bibby Sterilin Ltd, Stone Rd, Staffordshire ST15OSA, England) were used as bioassay units, and the medium used was oven dried and sieved Sydney sand.

To make the required barrier material, 90 g samples of sand were placed in 200 mL beakers and 10 mL aliquots of each serial dilution of 0.0, 0.1, 0.2 and 0.5% ai w/v were titrated on the sand while continuously mixing with a spatula. After mixing the beakers were covered with a plastic sheet wrap for 1-2 hours to ensure equilibration of 10% moistened sand with extract concentrations of 0.0, 100, 200 and 500 ppm (wt [ai]: wt moistened sand).

In the bottom of the tube, 3 pieces of 5 cm length wooden applicator sticks were placed together with 50 workers and 2 soldiers of C. acinaciformis which were transferred with a fine camel hair brush. A 3 cm core of 7.0% Agar gel (Avocado Research Chemicals Ltd, Shore Road, Heysham, Lancastershire) was inserted into the tube until it rested on the wooden sticks. Water-moistened sand (10% distilled water) was spooned into the tubes to a height of 4 cm. The tube was gently shaken and the sand surface was then lightly tamped and levelled using a clean handle of a screwdriver. A 1.0 cm barrier of freshly treated sand was then transferred from the beakers to the test tube with a small spatula and lightly tamped before inserting a 1.0 cm core of 7.0% agar gel over this “barrier” layer. A 10×50 mm paper towel strip was folded twice before being placed in the top of each tube. Aluminum foil (Glad Foil, Bow Street, Padstow NSW 2211, Australia) was then used to cover the top end of each tube. Each treatment was replicated 4 times. Tubes were held vertically in a cardboard packing box and maintained in the laboratory at 24±2° C. and 35-68% RH. Distances penetrated by the termites into both untreated and treated sand layers was monitored at 2, 6, 10 and 14 days after treatment.

Results:

Termite workers tunneled faster in the control treatment than all other treatments containing the E. mitchellii extract barrier. In the control bioassay tubes, termite workers had penetrated through the entire 5 cm sand layer (ie. sand and “barrier”) in all replicates within six days (Table 2). In the treatment bioassay tubes, no mortality was observed and so workers continued to tunnel through the 4cm untreated sand, but did not generally penetrate the final 1 cm treated sand barrier. Even after 14 days termites did not penetrate the 500 ppm treated barrier in any replicate, making a u-turn as they approached it. At the lower concentrations of barrier treatment tested (ie 100 and 200 ppm), three of four replicates showed no barrier penetration.

It is concluded that a 1 cm layer of sand treated with 500 ppm of E. mitchellii oil formed an effective barrier preventing termite incursion. The efficacy demonstrated here (i.e., 1 cm barrier of 500 ppm ai) is comparable with recently reported results for lower concentration but wider barriers using synthetic termiticides such as chlorpyrifos (Gahlhoff & Koehler, 2001).

The results are shown in Table 5.

TABLE 5

| | 1.1.1 Mean distance penetrated (cm) | | | |
|---|---|---|---|---|
| | | | | No penetrating |
| Oil ppm | After 2 days | After 6 days | After 14 days | barrier/4 |
| 0.00 | 4.0000 ± 2.4495 | 6.0000 ± 0.0000 | 6.0000 ± 0.0000 | 4 |
| 100.00 | 1.0000 ± 1.200 | 1.9000 ± 0.8406 | 3.9000 ± 1.6371 | 1 |
| 200.00 | 1.750 ± 1.1328 | 3.4250 ± 2.1077 | 4.5500 ± 2.2825 | 1 |
| 500.00 | 2.1750 ± 2.1422 | 2.8500 ± 1.5089 | 3.8750 ± 1.5564 | 0 |

The whole oil was an effective barrier to termite migration.

### Example 5

Choice Test

A plastic box measuring 35×24×14 cm was used as a test arena. In a choice test, ten extract-treated (extract+all components of the control) and ten control-treated (distilled water+ethanol solvent+200 ppm Triton X-100) filter papers (55 mm diameter Whatman No. 1, Whatman International Ltd, Maidstone, England) were distributed randomly inside the arena. The filter papers were treated by immersing them in the appropriate solution and leaving them to drain and air-dry, prior to placing them in the arena. Two hundred workers and 50 soldiers of N. walkeri were then transferred into the middle of the arena. Three drops of distilled water were applied twice a day to each filter paper to provide water for termites. The investigation was carried out in the laboratory at 24±1° C. and 35 to 68% RH. Observations were recorded visually from photographs taken eight hours and seven days after the termite release the termites. The photographs were enlarged and the number of termites on each filter paper counted. Each filter paper represented one of ten replicates. Data were analysed by ANOVA, and t-test using SPSS [symbol] for Windows™ Version 7 (SPSS Inc. 1997) to compare the means of the control-treated and the extract-treated filter papers.

Results

The mean number of workers and soldiers on the control-treated filter papers was 12.2±14.6 SD, which was significantly (P<0.05) more than the mean for the extract-treated filter paper, at 0.6±1.0 SD.

Throughout the investigation, termites were observed avoiding the extract-treated papers, moving around them and never under or across them. By contrast, termites walked over and under the control-treated filter papers, finally clustering and nesting beneath four of them where they remained for seven days. The other six control-treated filter papers were all located in close proximity to treated papers and remained free of termites for the duration of the investigation, although termites were observed crossing them.

### REFERENCES

Bates R B and Palmikar S K, Chem. Ind., 1971, 2170-2171.
Bradfield, A. E., Penfold, A. R. and Simonsen, J. L. (1932) J. Chem Soc., 2744 2759.
Bradfield, A. E., Penfold, A. R. and Simonsen, J. L. (1932) J. Proc. Roy. Soc. N.S.W., 1932, 66, 420-433.
Bradfield, A. E., Hellstrom, N., Penfold, A. R. and Simonsen, J. L. (1938) J. Chem Soc., 767.
Chetty G L, Zalkow L H; Tet Lett. 1969, 5, 307-309.
Djerassi, C., Markley, F. X. and Zalkow, L. H. (1960) J. Am. Chem. Soc., 82, 6354.
Fincini, J. and Touzin, A. M. (1977) Tet. Lett. 1081-1084.
Gahlhoff, J E & Koehler, P G (2001) Journal of Economic Entomology 94: (2) 486-491.
Ghisalberti, E. L. (1994) Phytochernistry, 35(1), 7-33.
Herron G A, Beattie G A, Parkes R A & Barchia I. (1995) Journal of the Australian Entomological Society. 34, 253-263.
Massy-Westropp R A and Reynolds G D, Aust. J Chem., 1966, 19, 303.
McMurray, J. E., Musser, J. H., Ahmad, M. S. and Blaszczak, L. C. (1975) J. Org. Chem., 40 (12), 1829-1832.
Pinder A R and Torrence A K, J. Chem. Soc. (C), 1971, 3410-3414.
Su N-Y, Gregory S W & Schheffrahn R H. (1995) Journal of the Entomological Society of America. 88: (6), 1690-1694.
Ziegler, F. E., Reid, G. R., Studt, W. L. and Wender, P. A. (1977), J. Org. Chem. 42(11) 1991-2001.
Massy-Westropp R A and Reynolds G D, Aust. J. Chem., 1966, 19, 303.

1. A pest controlling composition comprising at least one compound of formula (I) or a tautomer thereof: 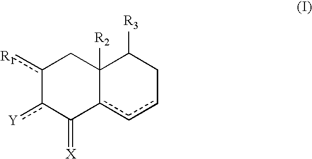
wherein:
X is selected from the group consisting of O, S or N—R₄;
when [symbol] is a single bond attached to Y, Y is selected from the group consisting of H, [C(R₇)₂]ₙhalo, [C(R₇)₂]ₙOR₅, [C(R₇)₂]ₙSR₅, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
when [symbol] is a double bond attached to Y, Y is O;
when [symbol] is a single bond attached to R₁, R₁ is selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
when [symbol] is a double bond attached to R₁, R₁ is CR₁ₐR_{1b} wherein R₁ₐ and R_{1b} are independently selected from C₁-C₁₀alkyl;
R₂ and R₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;
R₅ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, (C═O)R₆, PO₃R₈, SO₃R₈ and SO₂R₈;
R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;
R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;
R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl;
n is 0 or an integer selected from 1 to 5; 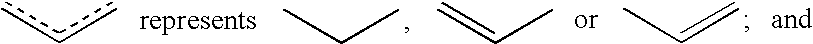
wherein each alkyl, alkenyl, alkynyl, cycloalkyl, cycloalkenyl, aryl and heterocyclyl group is optionally substituted.

2-19. (canceled)

20. A pest controlling composition comprising more than one compound of formula (I) or a tautomer thereof: 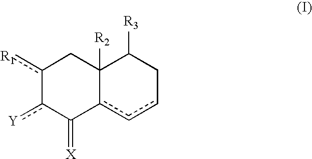
wherein:
X is selected from the group consisting of O, S or N—R₄;
when [symbol] is a single bond attached to Y, Y is selected from the group consisting of H, [C(R₇)₂]ₙhalo, [C(R₇)₂]ₙOR₅, [C(R₇)₂]ₙSR₅, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
when [symbol] is a double bond attached to Y, Y is O;
when [symbol] is a single bond attached to R₁, R₁ is selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
when [symbol] is a double bond attached to R₁, R₁ is CR^{1a}R^{1b} wherein RI, and R]b are independently selected from C₁-C₁₀alkyl;
R₂ and R₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;
R₅ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, (C═O)R₆, PO₃R₈, SO₃R₈ and SO₂R₈;
R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;
R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;
R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl;
n is 0 or an integer selected from 1 to 5; 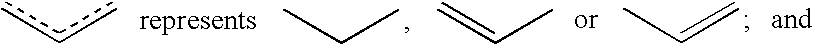
wherein each alkyl, alkenyl, alkynyl, cycloalkyl, cycloalkenyl, aryl and heterocyclyl group is optionally substituted.

21-25. (canceled)

26. A method for controlling pests, said method comprising exposing said pests to a pest-controlling effective amount of a compound of formula (I) or a tautomer thereof or a composition comprising at least one compound of formula (I) or a tautomer thereof: 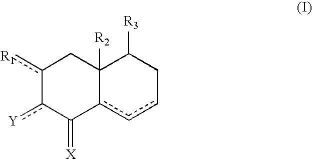
wherein:
X is selected from O, S or N—R₄;
when [symbol] is a single bond attached to Y, Y is selected from the group consisting of H, [C(R₇)₂]ₙhalo, [C(R₇)₂]ₙOR₅, [C(R₇)₂]ₙSR₅, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
when [symbol] is a double bond attached to Y, Y is O;
when [symbol] is a single bond attached to R₁, R₁ is selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
when [symbol] is a double bond attached to R₁, R₁ is CR₁ₐR_{1b} wherein R₁ₐ and R_{1b} are independently selected from C₁-C₁₀alkyl;
R₂ and R₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;
R₅ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, (C═O)R₆, PO₃R₈, SO₃R₈ and SO₂R₈;
R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;
R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;
R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl;
n is 0 or an integer selected from 1 to 5; 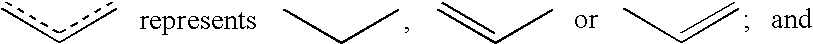
wherein each alkyl, alkenyl, alkynyl, cycloalkyl, cycloalkenyl, aryl and heterocyclyl group is optionally substituted.

27. A method according to claim 3 wherein the compound of formula (I) is a compound of formula (II): 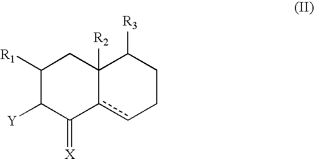
wherein:
X is selected from the group consisting of O, S or N—R₄;
Y is selected from the group consisting of H, [C(R₇)₂]ₙhalo, [C(R₇)₂]ₙOR₅, [C(R₇)₂]ₙSR₅, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
R₁, R₂ and R₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and ]C(R₇)₂]ₙNR₄OR₈;
each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;
R₅ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, (C═O)R₆, PO₃R₈, SO₃R₈ and SO₂R₈;
R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;
R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;
R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycIoalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl;
n is 0 or an integer selected from 1 to 5; [symbol]
represents a single or double bond; and
wherein each alkyl, alkenyl, alkynyl, cycloalkyl, cycloalkenyl, aryl and heterocyclyl group is optionally substituted.

28. (canceled)

29. A method according to claim 3, wherein at least one compound of formula (I) is a compound of formula (III): 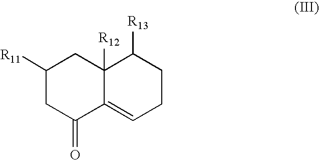
wherein
R₁₁ is selected from the group consisting of C₂-C₁₀ alkenyl, C₇-C₁₂ arylalkyl, C₆-C₁₂ heteroarylalkyl and C₂-C₁₀ alkenyloxy wherein each C₂-C₁₀ alkenyl or C₂-C₁₀ alkenyloxy is optionally substituted with 1 to 3 halo, hydroxy, thiol or nitro groups; and
R₁₂ and R₁₃ are independently selected from the group consisting of H, C₁-C₁₀ alkyl, C₂-C₁₀ alkenyl, C₂-C₁₀ alkynyl, C₆-C₁₀ aryl, C₇-C₁₂ arylalkyl, C₃-C₁₀ cycloalkyl, C₅-C₁₀ heteroaryl, C₆-C₁₂ heteroarylalkyl and C₁-C₁₀ alkoxy, wherein each C₁-C₁₀ alkyl and C₁-C₁₀ alkoxy is optionally substituted with 1 to 3 halo, hydroxy, thiol or nitro groups.

30. A method according to claim 5, wherein R₁₁ is C₂-C₁₀ alkenyl optionally substituted with a hydroxy, nitro or thiol group or 1 to 3 halo groups, and R₁₂ and R₁₃ are independently selected from C₁-C₁₀ alkyl optionally substituted with a hydroxy, nitro or thiol group or 1 to 3 halo groups.

31. A method according to claim 3 wherein at least one compound of formula (I) is eremophilone.

32. (canceled)

33. A method according to claim 3 wherein at least one compound of formula (I) is a compound of formula (IV): 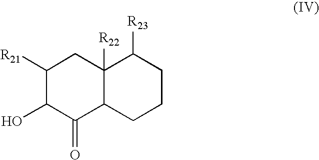
wherein R₂₁, R₂₂ and R₂₃ are independently selected from the group consisting of H, OH, SH, C₁-C₁₀ alkyl, C₂-C₁₀ alkenyl, C₂-C₁₀ alkynyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₄-C₁₀ cycloalkenylalkyl, C₃-C₁₀ heterocyclyl, C₄-C₁₂ heterocyclylalkyl, C₅-C₁₃ heterocyclylalkenyl, C₁-C₁₀ alkoxy, C₂-C₁₀ alkenyloxy, C₁-C₁₀ alkylthio, C₂-C₁₀ alkenylthio, [C(R₇)₂]ₙhalo, [C(R₇)₂]ₙ(C═O)R₆, [C(R₇)₂]ₙ(C═S)R₆, [C(R₇)₂]ₙN(R₄)₂, [C(R₇)₂]ₙ(C═NR₄)R₆, [C(R₇)₂]ₙNO₂ and [C(R₇)₂]ₙNR₄OR₈;
each R₄ is independently selected from the group consisting of H, OH, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₃-C₁₀ heterocyclyl, C₄-C₁₂ heterocyclylalkyl, C₅-C₁₃ heterocyclylalkenyl, C₁-C₁₀ alkoxy and C₂-C₁₀ alkenyloxy;
R₆ is selected from the group consisting of H, OH, C₁-C₁₀ alkoxy, C₁-C₁₀ alkyl, C₂-C₁₀ alkenyloxy, C₂-C₁₀ alkenyl, C₆-C₁₀ aryl, C₆-C₁₀ aryloxy, C₃-C₆ cycloalkyl, C₃-C₆ cycloalkenyl, C₃-C₆ cycloalkyloxy, C₃-C₆ cycloalkenyloxy, C₃-C₁₀ heterocyclyl, C₃-C₁₀ heterocyclyloxy, C₁-C₁₀ alkylthio, C₁-C₁₀ alkenylthio, C₆-C₁₀ arylthio, C₃-C₆ cycloalkylthio, and C₃-C₁₀ heterocyclylthio;
R₇ is selected from the group consisting of H, halogen, OR₅, SR₅, N(R₄)₂, (C═O)R₆, (C═S)R₆, C₁-C₁₀ alkyl, C₂-C₁₀ alkenyl, C₆-C₁₀ aryl, C₃-C₁₀ heterocyclyl, C₃-C₆ cycloalkyl, C₇-C₁₂ arylalkyl, C₄-C₁₂ heterocyclylalkyl, C₄-C₁₀ cycloalkylalkyl, C₈-C₁₃ arylalkenyl, C₅-C₁₃ heterocyclylalkenyl, and NO₂;
R₈ is selected from the group consisting of H, C₁-C₁₀ alkyl, C₂-C₁₀ alkenyl, C₆-C₁₀ aryl, C₇-C₁₂ arylalkyl, C₈-C₁₃ arylalkenyl, C₃-C₆ cycloalkyl, C₃-C₆ cycloalkenyl, C₄-C₁₀ cycloalkylalkyl, C₅-C₁₀ cycloalkylalkenyl, C₃-C₁₀ heterocyclyl, C₄-C₁₂ heteocyclylalkyl and C₅-C₁₃ heterocyclylalkenyl; and
n is 0 or an integer selected from 1 to 5;
wherein each alkyl, alkenyl, alkynyl, cycloalkyl, cycloalkenyl, aryl and heterocyclyl group is optionally substituted.

34. A method according to claim 8 wherein R₂₁ is selected from the group consisting of C₂-C₁₀ alkenyl, C₇-C₁₂ arylalkyl, C₆-C₁₂ heteroarylalkyl and C₂-C₁₀ alkenyloxy wherein each C₂-C₁₀ alkenyl or C₂-C₁₀ alkenyloxy is optionally substituted with 1 to 3 halo, hydroxy, thiol or nitro groups; and
R₂₂ and R₂₃ are independently selected from the group consisting of H, C₁-C₁₀ alkyl, C₂-C₁₀ alkenyl, C₂-C₁₀ alkynyl, C₆-C₁₀ aryl, C₇-C₁₂ arylalkyl, C₃-C₁₀ cycloalkyl, C₅-C₁₀ heteroaryl, C₆-C₁₂ heteroarylalkyl and C₁-C₁₀ alkoxy, wherein each C₁-C₁₀ alkyl and C₁-C₁₀ alkoxy is optionally substituted with 1 to 3 halo, hydroxy, thiol or nitro groups.

35. A method according to claim 9 wherein R₂₁ is C₂-C₁₀ alkenyl, optionally substituted with a hydroxy, thiol or nitro group or 1 to 3 halo groups, and R₂₂ and R₂₃ are independently selected from C₁-C₁₀ alkyl, optionally substituted with a hydroxy, thiol or nitro group or 1 to 3 halo groups.

36. A method according to claim 3 wherein at least one compound of formula (I) is 8-hydroxy-1(10)dihydroeremophilone.

37. (canceled)

38. A method composition according to claim 3 comprising at least one compound of formula (V): 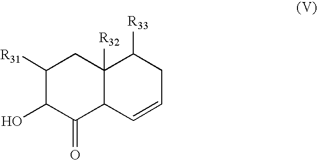
wherein R₃₁ is selected from the group consisting of C₂-C₁₀ alkenyl, C₇-C₁₂ arylalkyl, C₆-C₁₂ heteroarylalkyl and C₂-C₁₀ alkenyloxy wherein each C₂-C₁₀ alkenyl or C₂-C₁₀ alkenyloxy is optionally substituted with 1 to 3 halo, hydroxy, thiol or nitro groups; and
R₃₂ and R₃₃ are independently selected from the group consisting of H, C₁-C₁₀ alkyl, C₂-C₁₀ alkenyl, C₂-C₁₀ alkynyl, C₆-C₁₀ aryl, C₇-C₁₂ arylalkyl, C₃-C₁₀ cycloalkyl, C₅-C₁₀ heteroaryl, C₆-C₁₂ heteroarylalkyl and C₁-C₁₀ alkoxy, wherein each C₁-C₁₀ alkyl and C₁-C₁₀ alkoxy is optionally substituted with 1 to 3 halo, hydroxy, thiol or nitro groups.

39. A method according to claim 12 wherein R₃₁ is C₂-C₁₀ alkenyl optionally substituted with a hydroxy, nitro or thiol group or 1 to 3 halo groups, and R₃₂ and R₃₃ are independently selected from C₁-C₁₀ alkyl optionally substituted with a hydroxy, nitro or thiol group or 1 to 3 halo groups.

40. A method according to claim 3 wherein at least one compound of formula (I) is 8-hydroxyeremophila-1,11-dienone.

41. A method according to claim 3 wherein the composition comprises an extract containing at least one compound of formula (I) obtained from a volatile oil bearing plant from the Myoporaceae family.

42. (canceled)

43. (canceled)

44. A method according to claim 3 wherein the pest-controlling effective amount is a pesticidally effective amount.

45. A method according to claim 3 wherein the pest-controlling effective amount is a pest-repelling effective amount.

46. A method according to claim 3 wherein the pest-controlling effective amount is a antifeedant effective amount.

47. A method according to claim 3 wherein the pests are selected from the group consisting of insects, arachnids, helminths and molluscs.

48. A method according to claim 3 wherein the pests are selected from the group consisting of termites, earwigs, cockroaches and wood borer beetles and their larvae.

49. A method according to claim 3 wherein the pests are wood associated pests.

50. A method according to claim 21 wherein the wood associated pests are selected from the group consisting of termites and wood borer beetles.

51. A method according to claim 22 wherein the wood associated pests are termites.

52. A method according to claim 3 wherein pests are exposed to the pest-controlling effective amount of a compound of formula (I) or a composition comprising at least one compound of formula (I) by applying the compound or composition to a site of infestation, a potential site of infestation, a habitat of the pest or a potential habitat of the pest.

53. A method according to claim 24 wherein the compound or composition is applied to a surface or impregnated into a material or article of manufacture.

54. A method according to claim 25 wherein the compound or composition is applied to a surface by spraying, coating or painting the surface.

55. A method according to claim 26 wherein the surface is a soil surface, timber, buildings, wooden articles of manufacture or a physical barrier.

56. A method according to claim 27 wherein the material or article of manufacture is soil, timber, timber or wooden products or buildings or parts of buildings.

57. A method according to claim 24 wherein the compound. or composition is applied in a band or furrow around a site of infestation or potential infestation or is mixed with a layer of soil at a site of infestation or a potential site of infestation.

58. A material or article of manufacture for use in pest control that is coated or impregnated with at least one compound of formula (D) as defined in claim 1 or a tautomer thereof or with a composition containing at least one compound of formula (I) as defined in claim 1 or a tautomer thereof and wherein the article of manufacture is selected from the group consisting of a pest shield, a pest barrier, soil and a timber product.

59-76. (canceled)

77. A pest control coating comprising a composition according to claim 1.

78. (canceled)

79. A method of combating an already existing wood associated pest infestation comprising applying a composition according to claim 1 to a wood associated pest affected surface.

80. (canceled)

81. (canceled)

82. A method of combating an already existing wood associated pest infestation comprising applying a coating of claim 31 to a wood associated pest affected surface.
